(19) United States
(12) Patent Application Publication
(10) Pub. No.: US 2006/0069187 A1
(43) Pub. Date: Mar. 30, 2006

(54) Functionalized polyolefin emulsions

(76) Inventor: Daniel W. Klosiewicz, Kingsport, TN (US)

Correspondence Address: Polly C. Owen;Eastman Chemical Company, P.O. Box 511, Kingsport, TN, 37662-5075, US

(21) Appl. No.: 11/031,920

(22) Filed: Jan. 7, 2005

Related U.S. Application Data
(60) Provisional application No. 60/614,087, filed on Sep. 29, 2004.
(60) Provisional application No. 60/614,156, filed on Sep. 29, 2004.
(60) Provisional application No. 60/614,138, filed on Sep. 29, 2004.
(60) Provisional application No. 60/614,097, filed on Sep. 29, 2004.

(51) Int. Cl. C08K 5/09

(52) U.S. Cl. 524/284; 524/379

(57) ABSTRACT

Functionalized polyolefin emulsions are provided comprising at least one functionalized polyolefin, at least one non-ionic surfactant, at least one neutralizing base, at least one carboxylic acid co-surfactant, and water; wherein the carboxylic acid co-surfactant is selected from the group consisting of a linear organic carboxylic acid and an alicyclic carboxylic acid.

### CROSS REFERENCES TO RELATED APPLICATIONS

This application claims the benefit of U.S. Provisional Application entitled “Functionalized Polyolefin Emulsions” having Ser. No. 60/614,087 filed Sep. 29, 2004, U.S. Provisional Application entitled “Processes for Producing Functionalized Polyolefin Emulsions” having Ser. No. 60/614,156 filed on Sep. 29, 2004, U.S. Provisional Application entitled “Alicyclic Carboxylic Acid-Containing Functionalized Polyolefins” having Ser. No. 60/614,138 filed Sep. 29, 2004, and U.S. Provisional Application entitled “Heat Stable Functionalized Polyolefin Emulsions” having Ser. No. 60/614,097 filed Sep. 29, 2004; all of which are hereby incorporated by reference in their entireties to the extent they do not contradict the statements herein.

### FIELD OF THE INVENTION

The present invention relates to functionalized polyolefin emulsions comprising at least one functionalized polyolefin, at least one non-ionic surfactant, at least one neutralizing base, at least one carboxylic acid co-surfactant, and water.

The present invention also relates to processes for producing functionalized polyolefin emulsions and to articles comprising functionalized polyolefin emulsions.

### BACKGROUND OF THE INVENTION

Aqueous emulsions of various types of functionalized polyolefins have been used commercially since the late 1950s. Various methods for emulsifying low molecular weight polyolefins have been described by Force, in U.S. Pat. No. 3,912,673, von Bramer et al., “Polish Emulsion by Pressure Method,” Soap and Chemical Specialties, December, 1966, and Nalley et al., U.S. Pat. No. 3,655,353.

Emulsions of functionalized polyolefins have a variety of uses. For examples, emulsions of functionalized polyolefins are used in floor and car polishes, temporary metal coatings, corrugated and paper coatings, textile softener and lubricants, fiberglass sizing, and paper calendaring lubricants and citrus fruit coatings. However, the use of low molecular weight polyolefins in functionalized polyolefin emulsions can yield coatings having insufficient properties, such as, hardness. In addition, higher graft levels can increase color bodies in the functionalized polyolefins. Thus, there is a need for improved emulsions of high molecular weight functionalized polyolefins, in particular, emulsions of maleated polypropylene in order to improve, for example, mechanical properties and color.

Using current technology, it has been found that emulsifying high molecular weight functionalized polyolefins, especially maleated polypropylenes, has been extremely difficult. Generally, the difficulty of emulsifying a maleated polypropylene increases as the molecular weight and melt point of the maleated polypropylene increases. In addition, as the maleation level of the maleated polypropylene decreases, likewise the difficulty of emulsifying increases.

The use of functionalized polyolefins emulsions, particularly, maleated polypropylene emulsions, has particular use in sizing formulations for fibers, especially glass fibers to produce polymer/fiber composite materials. For example, sizing formulations based on emulsions of low molecular weight maleated polypropylene, such as Epolene E-43 maleated polypropylene produced by Eastman Chemical Company, have been used for a number of years to size glass fibers used to produce, for example, polypropylene/glass composite blends.

Various sizing formulations have been used in the fiber industry to maximize the fiber-polymer interaction. These sizing formulations include ingredients that collectively form an interphase between the fibers and the polymer. For glass fibers, the sizing formulation typically include a polymer, emulsion, for example, a maleated polypropylene emulsion, and other chemical ingredients.

Often times, the use of the low molecular weight polypropylene emulsions can cause the polypropylene/glass composite not to be strong enough to meet specifications. To enhance the polypropylene/glass composite properties, it has become common practice to add a high molecular weight functionalized polypropylene, as a coupling agent, in solid form during the compounding stage of the manufacturing process. However, there are drawbacks to this process. While emulsions of low molecular weight maleated polypropylene are effective for the sizing function, they can also interact with an aminosilane coupling agent applied with the glass fibers. This interaction can interfere with the interaction of the higher molecular maleated polypropylene coupling agent additionally added to the polypropylene/glass composite. The net effect is that this interaction of the low molecular weight maleated polypropylene emulsion with the aminosilane can negate to some extent the desired positive interaction of the higher molecular weight maleated polypropylene coupling agent with the glass fiber surface. This can reduce to some extent the mechanical properties of the polypropylene/glass composite.

If the higher molecular weight maleated polypropylene typically used as a coupling agent in these polypropylene/glass composites can be emulsified into useful sizing formulations, the size coating does not suffer from the drawback described above. Since the maleated polypropylene emulsion used in the size coating is similar in character to the maleated polypropylene serving as a coupling agent, the interaction of the size coating with the aminosilane glass surface does not produce the same negative interaction as when the maleated polypropylene size has very low molecular weight. The result is that the mechanical properties of the polypropylene/glass composite can be improved in this way.

Therefore, there is a need for functionalized polyolefin emulsions comprising high molecular weight, low graft level, functionalized polyolefins and processes for producing these emulsions.

### BRIEF SUMMARY OF THE INVENTION

It is an object of this invention to provide functionalized polyolefin emulsions.

It is also an object of this invention to provide processes to produce functionalized polyolefin emulsions.

It is a further object of this invention to provide sizing compositions comprising the functionalized polyolefin emulsions.

It is yet another object of this invention to provide articles comprising the functionalized polyolefin emulsions.

In accordance with an embodiment of this invention, a functionalized polyolefin emulsion is provided comprising at least one functionalized polyolefin, at least one non-ionic surfactant, at least one neutralizing base, at least one carboxylic acid co-surfactant, and water;

wherein the functionalized polyolefin has a grafting level ranging from about 0.5% by weight grafted functionalizing agent to about 2.5% by weight grafted functionalizing agent based on the weight of the functionalized polyolefin; and wherein the non-ionic surfactant has a HLB ranging from about 4 to about 10; and wherein the carboxylic acid co-surfactant comprises at least one linear organic carboxylic acid in an amount less than or equal to 16 parts per hundred parts of the functionalized polyolefin.

In accordance with another embodiment of this invention, a functionalized polyolefin emulsion is provided comprising at least one functionalized polyolefin, at least one non-ionic surfactant, at least one neutralizing base, at least one carboxylic acid co-surfactant, and water; wherein the functionalized polyolefin has a grafting level ranging from about 0.5% by weight grafted functionalizing agent to about 2.5% by weight grafted functionalizing agent based on the weight of the functionalized polyolefin; wherein the non-ionic surfactant has a HLB ranging from about 4 to about 10; wherein the carboxylic acid co-surfactant comprises at least one linear organic carboxylic acid and at least one alicyclic organic carboxylic acid; and wherein the total amount of the carboxylic acid co-surfactant is greater than 16 parts per hundred parts of the functionalized polyolefin.

In accordance with another embodiment of this invention, a functionalized polyolefin emulsion is provided comprising at least one functionalized polyolefin, at least one non-ionic surfactant, at least one neutralizing base, at least one carboxylic acid co-surfactant, and water; wherein the carboxylic acid co-surfactant comprises at least one alicyclic organic carboxylic acid.

In accordance with another embodiment of this invention, a functionalized polyolefin emulsion is provided comprising at least one functionalized polyolefin, at least one non-ionic surfactant, at least one neutralizing base, at least one carboxylic acid co-surfactant, and water wherein the functionalized polyolefin has a grafting level from about 0.5% by weight grafted functionalizing agent to about 2.5% by weight grafted functionalizing agent; and wherein the functionalized polyolefin emulsion has a % transmittance of at least 5%.

In accordance with another embodiment of this invention, sizing compositions comprising at least one functionalized polyolefin emulsion are provided.

In accordance with yet another embodiment of this invention, articles are provided comprising at least one functionalized polyolefin emulsion.

Embodiments of this invention provide functionalized polyolefin emulsions comprising a functionalized polyolefin having a higher molecular weight and lower grafting level that has been previously thought of as being difficult or impossible to emulsify. The functionalized polyolefin emulsions of this invention exhibit at least one of the following advantages: 1) little residue after emulsification, 2) a small particle size thereby producing good transmittance for the diluted emulsion, 3) very fast filtration characteristics indicating minimal particles to clog filters, 4) high degree of reproducibility in the process for producing the functionalized polyolefin emulsions, 5) excellent coating characteristics, and 6) good color and color retention after heat aging.

### BRIEF DESCRIPTION OF THE DRAWINGS

FIG. 1 shows the particle size distribution of Comparative Example 1.

FIG. 2 shows the particle size distribution of Comparative Example 2.

FIG. 3 shows the particle size distribution of Example 1.

FIG. 4 shows the particle size distribution of Example 3.

FIG. 5 shows the particle size distribution of Example 4.

FIG. 6 shows the particle size distribution of Example 12.

FIG. 7 shows the particle size distribution of Example 14.

### DETAILED DESCRIPTION

In one embodiment of this invention, a functionalized polyolefin emulsion is provided comprising at least one functionalized polyolefin, at least one non-ionic surfactant, at least one neutralizing base, at least one carboxylic acid co-surfactant, and water wherein the functionalized polyolefin has a grafting level ranging from about 0.5% by weight grafted functionalizing agent to about 2.5% by weight grafted functionalizing agent based on the weight of the functionalized polyolefin; wherein the non-ionic surfactant has a HLB ranging from about 4 to about 10; and wherein the carboxylic acid co-surfactant comprises at least one linear organic carboxylic acid in an amount less than or equal to 16 parts per hundred parts of the functionalized polyolefin.

The functionalized polyolefin can be any functionalized polyolefin that is known in the art. As used herein, functionalization of polyolefins refers to the addition of acid groups to the polyolefin by a functionalizing agent. Functionalization can be achieved by any method known in the art. For example, thermal oxidation and grafting are processes that can be utilized.

In one embodiment of the invention, the polyolefins to be functionalized comprise at least one olefin monomer having from 2 to about 8 carbon atoms, preferably from 2 to about 6 carbon atoms. Examples of such polyolefins include, but are not limited to, polyethylene, polypropylene, polybutene, and polyhexene. The polyolefins to be functionalized can be homopolymers, copolymers, or terpolymers. Preferred polyolefins are homopolymers and copolymers of low, medium, and high density polyethylene and homopolymers and copolymers of crystalline and amorphous polypropylenes. More preferred are crystalline homopolymers or copolymers of propylene. Other suitable polyolefins, include, but are not limited to, thermoplastic elastomers such as ethylene-propylene rubber (EPR) and ethylene-propylene-diene rubber (EPDM).

The functionalizing agent can be any that are known in the art. In one embodiment, the functionalizing agent can be any unsaturated monomer containing one or more carboxylic acid or acid anhydride groups that can functionalize the polyolefin. Examples of suitable functionalizing agents are carboxylic acids, such as, acrylic acid and methacrylic acid, and acid anhydrides, such as, maleic anhydride. Further functionalizing agents include, but are not limited to, unsaturated monocarboxylic acids, polycarboxylic acids, and cyclic acid anhydrides. Specifically included herein are acids, such as, maleic acid, flumaric acid, himic acid, itaconic acid, citraconic acid, mesaconic acid, acrylic acid, methacrylic acid, crotonic acid, isocrotonic acid, and acid anhydrides, such as, maleic anhydride and himic anhydride. In one embodiment of this invention, the use of maleic anhydride is preferred for the functionalization of polypropylene. Mixtures of functionalizing agents may be utilized in the present invention.

Polyolefins having a grafting level of about 0.5% by weight to about 2.5% by weight grafted functionalizing agent based on the weight of the functionalized polyolefin can be emulsified in this invention. Preferably, the grafting level can range from about 1.2% by weight to about 2% by weight grafted functionalizing agent based on the weight of the functionalized polyolefin. When the functionalized polyolefin is maleated polypropylene, the grafting level can range from about 0.5% by weight to about 2.5% by weight grafted maleic anhydride, preferably from about 1% by weight to about 2.5% by weight, and most preferably from 1.3% by weight to 2.0% by weight of grafted maleic anhydride based on the weight of the maleated polypropylene. The graft level (% by weight grafted functionalizing agent based on the weight of the functionalized polyolefin) is calculated from the acid number. Lower graft levels result in maleated polypropylene having lighter color, which can be advantageous in certain applications. In addition, lower graft levels can also minimize polymer degradation.

In one embodiment of the invention, the graft distribution of the functionalized polyolefin should be with good uniformity in order to produce high quality functionalized polyolefin emulsions. For example, with maleated polypropylene, where the maleic anhydride reacts to form highly grafted oligomeric species and a substantial amount of the polyolefin remains unmodified, the functionalized polyolefin can be difficult or impossible to emulsify even though the graft level, calculated from the acid number, may indicate maleic anhydride content in the desired range.

The grafting level is calculated from the acid number of the functionalized polyolefin. The acid number of a functionalized polyolefin is the number of milligrams of potassium hydroxide that is required to neutralize the functional group present in 1 gram of the functionalized polyolefin where the test is designed to consume 1 millimole of potassium hydroxide for every millimole of functional group present. For example, when titrating grafted maleic anhydride groups, methanolic potassium hydroxide is used so that each maleic functionality consumes only one potassium hydroxide even though maleic anhydride can form a diacid. The acid number is obtained by titrating weighed samples of functionalized polyolefin dissolved in refluxing xylene with methanolic potassium hydroxide using phenolphthalein as an indicator. The acid number is distinguished from the saponification number which is measured in an aqueous system while the acid number is measured in a water-free system. By using an aqueous system for the titration of the functionalized polyolefin, the functionalizing agent is hydrolyzed, and twice the amount of potassium hydroxide is needed for neutralization. Therefore, the saponification number is twice as high as the acid number.

The acid number of the functionalized polyolefin can range from about 4 to about 14, preferably from 6 to 12. Acid numbers for maleated polypropylene can range from about 4 to about 14, preferably from 7 to 12.

Polymer strength is positively correlated with molecular weight; therefore, higher molecular weight functionalized polyolefins generally can have more desirable physical properties than lower molecular weight functionalized polyolefins. In one embodiment of this invention, the weight average molecular weight of the functionalized polyolefin can range from about 30,000 to about 90,000, preferably ranging from 40,000 to 70,000 for most of the uses described previously. The weight average molecular weight for maleated polypropylene can range from about 30,000 to about 90,000, preferably from 40,000 to 70,000.

The melt viscosity at 190° C. of the functionalized polyolefin is that which is sufficient to obtain properties useful in the application for the functionalized polyolefin emulsion. The melt viscosity at 190° C. was measured using a Thermosel viscometer manufactured by the Brookfield Instrument Company. In one embodiment of this invention, the melt viscosity at 190° C. is greater than 10,000 centipoise, preferably ranging from about 20,000 centipoise to about 150,000 centipoise, and most preferably ranging from 40,000 centipoise to 100,000 centipoise. The melt viscosity for maleated polypropylene can range from about 20,000 to about 150,000, preferably from 40,000 to 100,000.

The peak melt point measured by differential scanning calorimetry of the functionalized polyolefin is that which is sufficient to obtain properties useful in the particular application for the functionalized polyolefin emulsion. In one embodiment of this invention, the peak melt point of the functionalized polyolefin is greater than about 135° C., preferably greater than 150° C. The peak melt point for maleated polypropylene can range from about 135° C. to about 165° C., preferably from 155° C. to 165° C.

The amount of the functionalized polyolefin contained in the functionalized polyolefin emulsion is that which is sufficient to obtain properties useful in the particular application of the functionalized polyolefin emulsion. In one embodiment of this invention, the amount of the functionalized polyolefin can range from about 10% by weight to about 35% by weight based on the weight of the functionalized polyolefin emulsion, preferably from 20% by weight to 30% by weight. For maleated polypropylene emulsions, the amount of maleated polypropylene can range from about 10% by weight to about 35% by weight based on the weight of the maleated polypropylene emulsion, preferably from 20% by weight to 30% by weight.

The functionalized polyolefin can be produced by any process known in the art. The process can be either batch or continuous. In a batch process, generally, all of the reactants and products are maintained in the reaction vessel for the entire batch preparation time. In a continuous process, the ingredients are feed at a continuous rate to the process.

Typical processes for producing functionalized polyolefins include, but are not limited to, solid phase, solvent, or extrusion processes. In a solid phase process, the polyolefin is heated to a temperature below the melting point of the polyolefin. Then, the functionalizing agent and initiator are added to the heated polyolefin to produce the functionalized polyolefin. U.S. Pat. Nos. 4,595,726 and 5,140,074, herein incorporated by reference in their entirety to the extent they do not contradict the statements herein, utilize the solid phase process.

In solvent processes, solvent is added to swell the polyolefin to allow functionalization by the functionalizing agent. U.S. Pat. Nos. 4,675,210 and 4,599,385, herein incorporated by reference in their entirety to the extent they do not contradict the statements herein, utilize the solvent process.

In extrusion processes, the polyolefin, functionalizing agent, and at least one initiator are fed to an extrusion zone where grafting takes place. The extrusion zone comprises at least one extruder. U.S. Pat. Nos. 5,955,547, 6,046,279, and 6,218,476, herein incorporated by reference in their entirety to the extent they do not contradict the statements herein, describe extrusion processes for producing functionalized polyolefins, particularly maleated polypropylenes.

The functionalized polyolefins, particularly maleated polypropylene, can also be characterized into two product types as a function of whether or not solvent is utilized, either as a solvent during reaction or in workup of the functionalized polyolefins. In U.S. Pat. Nos. 3,414,551; 4,506,056; and 5,001,197, herein incorporated by reference in their entirety to the extent they do not contradict the statements herein, the workup of the functionalized polyolefin involves dissolving the functionalized polyolefin in a solvent followed by precipitation, or washing with solvent. This treatment removes soluble components and thus varies both the ‘apparent’ molecular weight and acid number.

In one particular embodiment of this invention, the maleated polypropylene is prepared by an extrusion process utilizing a polypropylene having a peak melt point greater than 135° C. The polypropylene is combined in the melt with maleic anhydride that is added at a level between about 1.0 parts to about 2.5 parts per 100 parts of polypropylene, and the peroxide initiator is added at a level up to about 2.0% by weight based on weight of the polypropylene. The polypropylene, maleic anhydride, and peroxide initiator are mixed in the extruder at a temperature in the range of about 160° C. to about 250° C. The maleated polypropylene after stripping to remove unreacted maleic anhydride generally exhibits greater than about 1.2% reacted (grafted) maleic anhydride measured by acid titration using methanolic KOH.

The non-ionic surfactant used should have the proper HLB characteristics based on the graft level of the functionalized polyolefin to produce a stable functionalized polyolefin emulsion. A stable functionalized polyolefin emulsion is one where the ingredients do not separate or the particles do not agglomerate. Preferably, the functionalized polyolefin emulsion has a transmittance greater than 5%. The method of measuring transmittance is described subsequently in the examples section of this disclosure.

For non-ionic surfactants, which are amphiphallic and comprised of both a hydrophobic end and a hydrophillic ethylene oxide segment, HLB is an indicator of the relative amounts of hydrophillic and hydrophobic segments in the surfactant. The percentage of hydrophillic groups in the surfactant is roughly equal to (HLB/20)×100. For example, a non-ionic surfactant with a HLB equal to 10 has about 50% of its molecules consisting of polar ethylene oxide groups while a non-ionic surfactant with a HLB equal to 15 has about 75% of its structure as polar ethylene oxide units.

To emulsify functionalized polyolefins with graft levels greater than 2.5% by weight functionalizing agent based on the weight of the functionalized polyolefin, such as Epolene E-43 or G-3015 maleated polypropylene produced by Eastman Chemical Company, a non-ionic surfactant with a HLB value of about 11 to about 15 is typically used. Functionalized polyolefins having lower grafting level and higher molecular weight are more difficult to emulsify. In order to emulsify functionalized polyolefins having a graft level less than or equal to about 2.5% by weight functionalizing agent based on the weight of the functionalized polyolefin, it would be expected that non-ionic surfactants having higher HLB values should be utilized, but this is surprisingly not the case as discussed subsequently and as shown in the examples in this disclosure.

For example, Epolene G-3003 maleated polypropylene produced by Eastman Chemical Company with about 1.4 weight % grafted maleic anhydride based on the weight of the maleated polypropylene emulsifies well using non-ionic surfactants or mixtures of non-ionic surfactants having an average HLB value of between about 8 and about 9. As the grafting level of the functionalized polyolefin increases, the optimum HLB of the non-ionic surfactant increases with the increasing graft level in order to produce the optimum functionalized polyolefin emulsion as indicated by good transmittance and filterability. Good transmittance and filterability are defined in the Examples Section of this disclosure. For instance, the optimum HLB for the non-ionic surfactant to emulsify Epolene G-3015 maleated polypropylene produced by Eastman Chemical Company with about 3% grafted maleic anhydride ranges from about 11 to about 14. However, these same non-ionic surfactants fail to produce a stable functionalized polyolefin emulsion when used with Epolene G-3003 maleated polypropylene having a 1.4% grafting level.

When emulsifying functionalized polyolefins have a grafting level between about 0.5% by weight grafted functionalizing agent to about 2.5% by weight grafted functionalizing agent based on the weight of the functionalized polyolefin, the non-ionic surfactant can be any non-ionic surfactant or mixture of non-ionic surfactants known in the art having a HLB ranging from about 4 to about 10. As mentioned previously, optimal functionalized polyolefin emulsions are obtained by choosing the appropriate HLB range based on the grafting level of the functionalized polyolefin. Preferably, the HLB value of the non-ionic surfactant can range from about 6 to about 10, and most preferably from 7 to 10.

Preferably, non-ionic surfactants or non-ionic surfactant mixtures with a HLB value in the range of about 8 to about 9 tend to be most effective when emulsifying Epolene G-3003 maleated polypropylene. Most preferably, the non-ionic surfactant for producing emulsions of Epolene G-3003 maleated polypropylene (1.4 wt % maleic anhydride based on the weight of the maleated polypropylene) produced by Eastman Chemical Company is a roughly 70/30 mixture of Brij 30 and Brij 72 obtained from Uniquema Chemical Company where the calculated HLB of the blend is about 8.5. It has been found that non-ionic surfactants with even lower HLB values than 8.5 tend to require higher levels of carboxylic acid co-surfactant to produce stable emulsions.

Non-ionic surfactants include, but are not limited to, compounds based on ethylene oxide and alkyl phenols. Particular examples of suitable non-ionic surfactants include, but are not limited to, ethoxylated derivatives of C₈ to C₂₀ linear alcohols, ethoxylated C₉ to C₁₈ synthetic branched alcohols, ethoxylated alkyl phenol derivatives, mono esters of aliphatic carboxylic acids and polyethylene oxide oligomers of varying molecular weight, and similar mono- or di-esters of polyhydroxy material, such as, sorbitol-monolaurate. Of this group, non-ionic surfactants based on the reaction of alcohols or alkyl phenols with ethylene oxide, propylene oxide, or mixtures of the two are most preferred because of the stability of the ether linkage joining the hydrophilic and hydrophobic ends. Combinations of non-ionic surfactants can also be used. For example, combinations of non-ionic surfactants having high and low HLB values can be utilized to arrive at the HLB necessary to emulsify a particular functionalized polyolefin.

The amount of non-ionic surfactant present in the functionalized polyolefin emulsion is that which is sufficient to obtain a stable functionalized polyolefin emulsion. A stable functionalized polyolefin emulsion was previously defined in this disclosure. Preferably, the amount of the non-ionic surfactant present in the functionalized polyolefin emulsion is that which is sufficient to obtain an acceptable emulsion as indicated by a transmittance of at least 5%. In one embodiment, the amount of non-ionic surfactant can range from about 6 parts by weight per 100 parts by weight of functionalized polyolefin to about 25 parts by weight per 100 parts by weight of functionalized polyolefin, preferably from about 10 to about 20, and most preferably from 12 to 18.

The carboxylic acid co-surfactant is at least one selected from the group consisting of linear organic carboxylic acids and alicyclic organic carboxylic acids. The term “linear organic carboxylic acid” means any carboxylic acid structure which contains no cyclic or multi-cyclic groups and can include branched structures with no cyclic units. While not intended to be bound by any particular theory, the carboxylic acid co-surfactant is neutralized by the neutralizing base to form an anionic surfactant species. The linear organic carboxylic acid can be any known in the art that can emulsify the functionalized polyolefin to produce a stable functionalized polyolefin emulsion. A stable functionalized polyolefin emulsion was previously defined in this disclosure. Preferred examples of linear organic carboxylic acids include, but are not limited to, linear C₁₆ to C₁₈ fatty acids, such as, for example, oleic, stearic, or palmitoleic acid.

The alicyclic organic carboxylic acid can be any known in the art that can emulsify the functionalized polyolefin to produce a stable functionalized polyolefin emulsion. Examples of alicyclic organic carboxylic acid include, but are not limited to, rosin acids. Hydrogenated rosin acids, such as Foral AX-E rosin acid produced by Eastman Chemical Company, are particularly well suited for this invention because of the light color and stability imparted by hydrogenation.

In one embodiment of the invention, when emulsifying a functionalized polyolefin having a grafting level ranging from about 0.5% by weight to about 2.5% by weight grafted functionalizing agent based on the weight of the functionalized polyolefin, the amount of linear organic carboxylic acid is less than or equal to about 16 parts per 100 parts of functionalized polyolefin. Addition of an alicyclic organic carboxylic acid is not needed to obtain a stable functionalized polyolefin emulsion when the amount of the linear organic carboxylic acid is less than or equal to 16 parts per 100 parts of functionalized polyolefin. Preferably, when used alone in the emulsion formulation without an alicyclic carboxylic acid, the amount of linear organic carboxylic acid can range from about 2 to about 16 parts per hundred parts of functionalized polyolefin, most preferably from 8 to 12. It was surprising that the use of levels of linear organic carboxylic acid greater than 16 parts per 100 parts of functionalized polyolefin hindered emulsification and produced poorer quality emulsions as shown in the examples section.

However, when emulsifying functionalized polyolefins having a grafting level ranging from about 0.5% by weight to about 2.5% by weight grafted functionalizing agent based on the weight of the functionalized polyolefin and using a linear organic carboxylic acid in an amount less than or equal to 16 parts per hundred parts of functionalized polyolefin, improved emulsion properties, such as transmittance, can be obtained when at least one alicyclic organic carboxylic acid is also utilized in combination with the linear organic carboxylic acid. It is preferred to use mixtures of alicylic organic carboxylic acids with linear organic carboxylic acids when the total level of carboxylic acid co-surfactant in the emulsion is greater than 8 parts per hundred parts of functionalized polyolefin. When using both a linear organic carboxylic acid and alicyclic organic carboxylic acid, the total amount of carboxylic acid co-surfactant in the functionalized polyolefin emulsion is preferably in the range from about 8 parts to about 25 parts per hundred parts of functionalized polyolefin, most preferably, from 10 to 16. To obtain these improved emulsion properties, the amount of the alicyclic organic carboxylic acid can range from about 1% by weight to about 99% by weight of the total amount of carboxylic acid co-surfactant, preferably from 25% by weight to 75% by weight.

In another embodiment of this invention, it has been found that when the total amount of carboxylic acid co-surfactant is greater than 16 parts per 100 parts of functionalized polyolefin for functionalized polyolefins with grafting levels between about 0.5% by weight to about 2.5% by weight grafted functionalizing agent based on the weight of the functionalized polyolefin, the addition of alicyclic organic carboxylic acid, such as rosin acid, aids in the emulsification of the functionalized polyolefin whereas further addition of linear organic carboxylic acid deteriorates emulsion quality. In one embodiment of this invention, when the total amount of carboxylic acid co-surfactant is greater than 16 parts per hundred parts of functionalized polyolefin, the maximum amount of linear organic carboxylic acid should be 16 parts per hundred parts functionalized polyolefin and the remainder of the carboxylic acid co-surfactant should be alicylic organic carboxylic acid.

In another embodiment of this invention, the carboxylic acid co-surfactant is at least one alicyclic organic carboxylic acid. The amount of the alicyclic organic carboxylic acid is that which is sufficient to produce a stable functionalized polyolefin emulsion. A stable functionalized polyolefin emulsion was previously defined in this disclosure. In one embodiment of the invention, the amount of the alicyclic organic carboxylic acid can range from about 5 parts to 25 parts per hundred parts of functionalized polyolefin, preferably from 10 parts to 16 parts.

To emulsify the functionalized polyolefin, a neutralizing base is also used. While not intended to be bound by any particular theory, it is believed that the neutralizing base neutralizes the carboxylic acid co-surfactant to form a soap which acts as an emulsifier. It is also believed that the neutralizing base neutralizes functional groups on the functionalized polyolefin. Preferred bases are organic compounds having 1 to about 10 carbon atoms, an amino group, and a hydroxyl group. Preferred bases include, but are not limited to, N,N-diethylethanolamine, N,N-dimethyl ethanolamine, 2-dimethylamino-2-methyl-1 propanol, 2-dimethylamino-1-propanol, or combinations thereof.

Additionally, when a maleated polypropylene emulsion is dried, the neutralizing base can be volatile enough that it evaporates, which can allow the anhydride group in the maleated polypropylene to reform at higher temperatures. This behavior can be important in fiberglass sizing applications because the emulsion size can be reconverted to the anhydride form during drying, allowing the maleated polypropylene to also serve as coupling agent directly deposited onto the glass fiber.

The amount of neutralizing base is that which is sufficient to convert a portion of the carboxylic acid co-surfactant to an anionic surfactant and to neutralize a portion of the acid groups of the functionalized polyolefin. Generally, the amount of the neutralizing base in the functionalized polyolefin emulsion is not a fixed amount but depends on the total acidity of the functionalized polyolefin emulsion where the acidity is the combination of the carboxylic acid co-surfactant and the acidity of the grafted functional groups and the acidity of any emulsion additives. It is preferred that enough neutralizing base be used to neutralize about 80% to 100% of the total acidity in the functionalized polyolefin emulsion.

The remainder of the functionalized polyolefin emulsion is water.

In another embodiment of this invention, a functionalized polyolefin emulsion is provided comprising at least one functionalized polyolefin, at least one non-ionic surfactant, at least one neutralizing base, at least one carboxylic acid co-surfactant, and water; wherein the functionalized polyolefin has a grafting level from about 0.5% by weight to about 2.5% by weight grafted functionalizing agent based on the weight of the functionalized polyolefin; and wherein the carboxylic acid co-surfactant comprises at least one alicyclic carboxylic acid.

The functionalized polyolefin and at least one neutralizing base were previously discussed in this disclosure.

The non-ionic surfactant was also previously discussed in this disclosure and is selected based on the graft level of the functionalized polyolefin.

The carboxylic acid co-surfactant is at least one alicyclic organic carboxylic acid. Alicyclic organic carboxylic acids were discussed previously in this disclosure. In another embodiment of this invention, the carboxylic acid co-surfactant is at least one linear organic carboxylic acid and at least one alicyclic organic carboxylic acid.

In another embodiment of this invention, a functionalized polyolefin emulsion is provided comprising at least one functionalized polyolefin, at least one non-ionic surfactant, at least one neutralizing base, at least one carboxylic acid co-surfactant, and water; wherein the functionalized polyolefin has a grafting level from about 0.5% by weight to about 2.5% by weight grafted functionalizing agent based on the weight of the functionalized polyolefin; and wherein the functionalized polyolefin emulsion has a % transmittance of at least 5%. The functionalized polyolefin emulsion can also have good filterability. Good filterability is defined subsequently in the examples section of this disclosure.

In another embodiment of the invention, the size of the emulsion particles is so fine that the functionalized polyolefin emulsion can be filtered easily to produce a very clean product for making fine coatings. Particles larger than the pores of a filter element cause the filter to become clogged, making filtration very difficult. The functionalized polyolefin emulsion has good filterability if it passes the filterability test described subsequently in this disclosure.

Generally, the functionalized polyolefin emulsions have a transmittance value greater than 5%, preferably greater than 15%, and most preferably greater than 30%.

It is highly desirable that maleated polypropylene emulsions exhibit transmittance values greater than 5%, preferably greater than 10%, more preferred are maleated polypropylene emulsions with a transmittance greater than 20%, while the most desirable maleated polypropylene emulsions exhibit transmittance values greater than 30%. Emulsions of maleated polypropylene can be made which exhibit transmittance values of 60% or greater, particularly if the polypropylene is maleated to a higher degree usually having a grafting level of greater than 2%. Maleated polypropylene emulsions with transmittance values ranging from about 20% to about 35% or higher typically exhibit the coating and filtration behavior desired for emulsions of this type.

The functionalized polyolefin emulsion of this invention can be produced by any method known in the art. In one embodiment of the invention, a process to produce a functionalized polyolefin emulsion is provided comprising heating at least one functionalized polyolefin, at least one non-ionic surfactant, at least one neutralizing base, at least one carboxylic acid co-surfactant, and water to produce the functionalized polyolefin emulsion; wherein the functionalized polyolefin has a grafting level ranging from about 0.5% by weight grafted functionalizing agent to about 2.5% by weight functionalizing agent based on the weight of the functionalized polyolefin; wherein the non-ionic surfactant has a HLB ranging from about 4 to about 10; and wherein the carboxylic acid co-surfactant comprises at least one linear organic carboxylic acid in an amount less than or equal to 16 parts per hundred parts of the functionalized polyolefin.

In another embodiment of this invention, a process is provided to produce a functionalized polyolefin emulsion comprising heating at least one functionalized polyolefin, at least one non-ionic surfactant, at least one neutralizing base, at least one carboxylic acid co-surfactant, and water to produce the functionalized polyolefin emulsion; wherein the functionalized polyolefin has a grafting level ranging from about 0.5% by weight grafted functionalizing agent to about 2.5% by weight functionalizing agent based on the weight of the functionalized polyolefin; wherein the non-ionic surfactant has a HLB ranging from about 4 to about 10; wherein the carboxylic acid co-surfactant comprises at least one linear organic carboxylic acid and at least one alicyclic organic carboxylic acid; and wherein the total amount of the carboxylic acid co-surfactant is in an amount greater than 16 parts per hundred parts of the functionalized polyolefin.

In another embodiment of this invention, a process is provided to produce a functionalized polyolefin emulsion comprising heating at least one functionalized polyolefin, at least one non-ionic surfactant, at least one neutralizing base, at least one carboxylic acid co-surfactant, and water to produce the functionalized polyolefin emulsion, wherein the carboxylic acid co-surfactant comprises at least one alicyclic carboxylic acid.

In another embodiment of this invention, a process is provided to produce a functionalized polyolefin emulsion comprising heating at least one functionalized polyolefin, at least one non-ionic surfactant, at least one neutralizing base, at least one carboxylic acid co-surfactant, and water to produce the functionalized polyolefin emulsion; wherein the functionalized polyolefin has a grafting level from about 0.5% by weight grafted functionalizing agent to about 2.5% by weight grafted functionalizing agent based on the weight of the functionalizing polyolefin; and wherein the functionalized polyolefin emulsion has a % transmittance of at least 5%.

In all of these processes described previously to produce functionalized polyolefin emulsions, the emulsion can be produced by either a direct or indirect method. In a direct or batch method, the functionalized polyolefin, at least one non-ionic surfactant, at least one neutralizing base, at least one carboxylic acid co-surfactant, and water are added to an emulsification vessel at the start of the batch to produce an emulsification mixture. The emulsification vessel is then heated to the desired emulsification temperature under the vapor pressure of the water. The temperature of the emulsification mixture is generally above the melting point of the functionalized polyolefin. The temperature of the emulsification mixture can range from about 140° C. to about 185° C. depending on the melting point of the functionalized polyolefin, prefererably from 165° C. to 180° C.

An advantage of the direct method is there is no need to charge materials to the emulsification vessel while it is under pressure. In addition, it is simple process that eliminates additional steps that add cost to the production of the functionalized polyolefin emulsion.

In the indirect method, first, the functionalized polyolefin and a portion of at least one of the other emulsion ingredients are heated above the melting point of the functionalized polyolefin, then the remaining emulsion ingredients are added in any order or combination at elevated temperatures.

In another embodiment of the invention, the alicyclic carboxylic acid can be incorporated in the functionalized polyolefin during the production of the functionalized polyolefin, compounded with the functionalized polyolefin, or added at any time in the emulsification process.

### EXAMPLES

This invention can be further illustrated by the following examples of preferred embodiments thereof, although it will be understood that these examples are included merely for purposes of illustration and are not intended to limit the scope of the invention unless otherwise specifically indicated.

Test Methods

Filterability was measured by filtering the functionalized polyolefin emulsion through a fine paint strainer, having a 48×64 mesh filtration area such as Product # ST-9014 sold by Paul Gardner Company, Inc. Acceptable filterability was found if the functionalized polyolefin emulsion flowed completely through the strainer within about 1-2 seconds after the amount of functionalized polyolefin emulsion (approx. 220 g) was poured into the strainer. Poor filterability was found if the functionalized polyolefin emulsion (approx. 220 g) required greater than about 10 seconds to drain through the filter, and the rate could be noted to slow as agglomerates or gels caused the porous screen to clog. In the worse case, the filtration would essentially stop as the filter area became completely blocked.

Particle size of the functionalized polyolefin emulsions was determined using a Mastersizer 2000E particle size analyzer obtained from Malvern Instruments, Inc. in Southborough, Mass. The particle size tests were conducted according to the instrument manufacturer's procedures. An auto sample on the instrument was utilized to select the test conditions.

Transmittance of the functionalized polyolefin emulsion was measured by diluting the functionalized polyolefin emulsion to 1% by weight in deionized water by mixing 1 gram of functionalized polyolefin emulsion with 99 grams of deionized water to produce a diluted emulsion. The diluted emulsion was transferred into a 13×100 mm test tube, and the % transmittance was measured using a laboratory spectrophotometer such as a Sequoia Turner Model 340 spectrophotometer obtained from Sequoia Turner or Spectronic 21 D spectrophotometer obtained from Milton Roy operating at a wavelength of 600 nm. Samples were tested using calibration and test procedures documented in the manufacturer operating literature supplied with the instruments. These test instruments measure the amount of light of a specific wavelength which passes through the 13 mm sample path as compared to pure water with nominal 100% transmittance.

As the size of the emulsion particles decreased and larger particles in the emulsion are eliminated, the functionalized polyolefin emulsion became more translucent in appearance, and the % transmittance increased. Functionalized polyolefin emulsions with % transmittance values less than about 10% tend to be very coarse emulsions which typically exhibit poorer filtration characteristics and give a rough coating suggesting the presence of gels or grit when a glass slide is coated with the emulsion and allowed to dry in an inverted position to form a thin film.

Recovered Emulsion Yield (%) was calculated by weighing the functionalized polyolefin emulsion recovered from a 220 gram emulsion charge after filtration in grams and dividing by 216 grams. 220 grams of material were added to the reactor, and 4 grams were assumed to have accumulated in the equipment and filter when transferring and filtering the functionalized polyolefin emulsion.

Residue was determined by removing and weighing the solids in the emulsification vessel before and after drying.

Overall Emulsion Quality was determined qualitatively by considering the residue amount, transmittance, and filterability of the functionalized polyolefin emulsion.

Procedures

A direct or batch process was used in all the examples. The maleated polypropylene, non-ionic surfactant, carboxylic acid co-surfactant, neutralizing base, water, and at least one additive were charged to an emulsification vessel to produce an emulsification mixture. Maleated polypropylene was present in the charge at a concentration of about 26% to about 27% based on the weight of the emulsification mixture. The non-ionic surfactant was added at levels based on the amount of maleated polypropylene charged. Likewise, the carboxylic acid co-surfactant was added to the emulsification vessel at a level based on the amount of maleated polypropylene used. The amount of the non-ionic surfactant and carboxylic acid co-surfactant are expressed in terms of parts of ingredient per 100 parts of maleated polypropylene (phr) charged to the emulsification vessel. The amounts of each ingredient are shown in the data tables. The neutralizing base was dimethylamino-2-methylpropanol (DMAMP-80) used as an 80% by weight solution (20% water). The remainder of the batch charge was water, and various low levels of additives for stabilizing the color and pH of the maleated polypropylene emulsion. In each emulsion example, hypophosphorous acid neutralized with potassium hydroxide was added to the emulsion charge at an amount equal to 0.15% by weight hypophosphorous acid and 0.13% potassium hydroxide based on the total emulsion charge. The basic emulsification formula used in these examples is shown in Table 1.

TABLE 1

| Ingredient | Amount |
|---|---|
| Maleated Polypropylene (Epolene | 26% by weight based on weight of |
| G-3003 obtained from Eastman | emulsification mixture |
| Chemical Company) | |
| Carboxylic acid co-surfactant(s) | 7-20 phr based on the amount of |
| | maleated polypropylene |
| Non-ionic surfactant | 17-20 phr based on the amount of |
| | maleated polypropylene |
| DMAMP-80 | Sufficient to neutralize 80% to 85% |
| | of acidity of the maleated |
| | polypropylene |
| Additives/modifiers | <1.0% of emulsification mixture |
| Water | Remainder |

The water was charged first to the reactor, followed by all the emulsification ingredients, and the maleated polypropylene was charged last. A 300 ml pressure reactor from Parr Equipment Company was used for the emulsifications.

After charging the ingredients, the reactor was sealed and heated to about 178° C. while agitating at about 400 rpm. The heating rate from 150° C. to about 178° C. was controlled at a rate between 1° C.-2° C. per minute. The emulsification mixture was typically stirred for 1 hour at 178° C. before cooling at a rate of typically 2° C.-3° C. per minute. Emulsion properties were found to be fairly insensitive to the emulsion cooling rate. Below about 140° C., after the maleated polypropylene re-crystallized, even faster cooling rates were typically used. It is highly desirable to be able to use fast cooling rates since this decreases the batch cycle time needed to make the maleated polypropylene emulsion.

### Comparative Example 1, Examples 1 and 2

### Addition of Alicyclic Carboxylic Acid

In Table 2, three examples are listed where maleated polypropylene emulsions were prepared from Eastman Epolene G-3003 maleated polypropylene using the emulsification process previously described. In these examples, the amount of carboxylic acid co-surfactant was held constant at 17.8 phr level, and the same non-ionic surfactant type and level was used. The non-ionic surfactant was a 68/32 mixture of Brij 30 and Brij 72 surfactants manufactured by Uniquema Chemical Company.

In Comparative Example 1, the carboxylic acid co-surfactant was only oleic acid. The maleated polypropylene emulsion was very poor with a low transmittance value of 2.8%, and it filtered slowly, clogging the filter mesh before the entire batch passed through.

In Example 1 about 40% of the oleic acid used in Comparative Ex. 1 was replaced by Eastman Foral AX-E hydrogenated rosin acid. The maleated polypropylene emulsion exhibited excellent properties, minimal residue, a much higher % transmittance (30%), and very rapid filtration characteristics.

In Example 2, about 60% of the oleic acid used in Comparative Example 1 was replaced by an equal amount of Foral AX-E rosin acid, and a maleated polypropylene emulsion similar in character to Example 1 was made, which exhibited marginally higher transmittance (33%) than the emulsion of Example 1.

When higher levels of carboxylic acid co-surfactant are used in the emulsion formula, typically greater than 16 phr, there are very distinct advantages to using alicyclic type carboxylic acids, in particular Foral AX-E hydrogenated rosin acid, to replace part of the carboxylic acid co-surfactant which is characterized by a linear molecular structure.

TABLE 2

| | Example | | |
|---|---|---|---|
| | Comp. 1 | Ex. 1 | Ex. 2 |
| Epolene G-3003, parts | 100 | 100 | 100 |
| (typical 26% by weight in | | | |
| emulsion) | | | |
| Carboxylic Acid Co-Surfactant | | | |
| Fatty Acid, (phr) | 17.8 | 10.5 | 7.3 |
| Foral AX-E rosin acid (phr) | — | 7.3 | 10.5 |
| Non-Ionic Surfactant | | | |
| HLB | 8.5 | 8.5 | 8.5 |
| Amount (phr) | 17 | 17 | 17 |
| Recovered Emulsion Yield (%) | 97.0% | 99.0% | 99.3% |
| Residue (grams) | 1-2 g | Trace | Trace |
| % Transmittance | 2.8% | 29.6% | 32.5% |
| Filtration | V. Slow | V. Fast | V. Fast |
| Overall Emulsion Quality | Poor | Excellent | Excellent |

### Examples 3-5

### Reduction in the Amount of the Carboxylic Acid Co-Surfactant

In Example 3, a maleated polypropylene emulsion was prepared using only oleic acid as the carboxylic acid co-surfactant, in the same manner as Comparative Example 1, but at a lower level of 11.6 phr oleic acid. The non-ionic surfactant in Example 3 was a 68/32 mixture of Brij 30 and Brij 70 surfactants obtained from Uniquema Chemical Company. In Example 4, a maleated polypropylene emulsion was produced in a similar manner as in Example 3 except the level of oleic acid co-surfactant was further reduced to 7.8 phr. The non-ionic surfactant used in Example 4 was a 74/26 mixture of Brij 30 and Brij 72 surfactant. In Example 5, a similar maleated polypropylene emulsion was made as in Examples 3 and 4 except that the oleic acid level was further reduced to 6.8 phr. The emulsion characteristics are listed in Table 3 and compared to the results for Comparative Example 1.

The first reduction in the oleic acid level in Example 3 caused a significant improvement in emulsion quality compared to Comparative Example 1, with the transmittance increasing from 2.8% to about 18%. The further reduction in oleic acid level in Example 4 further improved the emulsion quality, with the transmittance of the emulsion increasing to an optimal value of about 27%. In Example 5, a further reduction in oleic acid level deteriorated the quality of the emulsion compared to Example 4 because at this level of oleic acid, there was no longer sufficient carboxylic acid co-surfactant to completely emulsify the maleated polypropylene charge using the emulsification procedure described earlier, and therefore, the amount of non-emulsified residue increased.

The carboxylic acid co-surfactant is an essential emulsification ingredient for use in making emulsions of high molecular weight maleated polypropylene such as Epolene G-3003 maleated polypropylene produced by Eastman Chemical Company. From these Examples, it is evident that when linear organic carboxylic acid is used alone at levels greater than 16 phr, it serves to deteriorate the quality of the emulsion formed.

Examples 1 and 2 further illustrate that the required level of carboxylic acid co-surfactant to achieve complete emulsification of the high molecular weight maleated polypropylene can be added without negatively affecting emulsion quality if an alicyclic carboxylic acid, such as Eastman Foral AX-E hydrogenated rosin acid, is used to replace a portion of the linear organic carboxylic acid co-surfactant used in the emulsion formula.

TABLE 3

| | Example | | | |
|---|---|---|---|---|
| | Comp. 1 | Ex. 3 | Ex. 4 | Ex. 5 |
| Epolene G-3003, parts | 100 | 100 | 100 | 100 |
| (typical 26% in emulsion) | | | | |
| Carboxylic Acid | 17.8 | 11.6 | 7.8 | 6.8 |
| Co-Surfactant | | | | |
| Fatty Acid (phr) | | | | |
| Non-Ionic | | | | |
| Surfactant | | | | |
| HLB | 8.5 | 8.5 | 8.8 | 8.5 |
| Amount (phr) | 17 | 17 | 17 | 17 |
| Recovered | 97.0% | 99.0% | 98.3% | 92.5% |
| Emulsion Yield (%) | | | | |
| Residue (grams) | 1-2 g | <1 g | 1-2 g | 13 g |
| % Transmittance | 2.8% | 17.5% | 27.4% | 24.0% |
| Filtration | V. Slow | Fast | V. Fast | V. Fast |
| Overall Emulsion | Poor | Very | Excellent | V. Good |
| Quality | | Good | | |

### Comparative Examples 2 & 3 and Examples 6 and 7

### Varying the HLB of the Non-Ionic Surfactant

In Comparative Example 2 and Example 6, in Table 4, maleated polypropylene emulsions were made from Epolene G-3003 maleated polypropylene produced by Eastman Chemical Company using the same procedure as in Example 3 where 11.6 phr oleic acid were used as the carboxylic acid co-surfactant, but the non-ionic surfactant composition was varied in these two examples.

In Example 3, the non-ionic surfactant was a 68/32 mixture of Brij 30 and Brij 72 surfactants obtained from Uniqema Chemical Company having a calculated HLB value of 8.5. In Comparative Example 2, the non-ionic surfactant was a 68/32 mixture of Brij 30 and Genapol UD-50 surfactants having a calculated HLB value of 10.4. Genapol UD-50 surfactant is a product of Clariant Inc. In Example 6, the non-ionic surfactant was a 47/53 mixture of Brij 30 and Brij 72 having a calculated HLB value of about 7.4.

The emulsion quality in Comparative Example 2 using a non-ionic surfactant mixture with a high HLB of 10.4 was poor as exhibited by slow filtration and a transmittance value of only 1.3%. In Example 3, where the HLB value was 8.5, the emulsion quality was good due to the desirable non-ionic surfactant choice. In Example 6, where the HLB of the non-ionic surfactant was further reduced to 7.4, little change was noted relative to Example 3. The most preferred range of HLB for the non-ionic surfactant HLB ranges from about 7 to about 10 for making emulsions of high molecular weight, maleated polypropylene when an alicylic carboxylic acid is not used. Emulsion quality deteriorated when using non-ionic surfactants with HLB values greater than 10, and although not intending to be bound by theory, if the HLB of the non-ionic surfactant is not high enough, it can become insufficiently polar to cause emulsification unless the amount of carboxylic acid co-surfactant is modified to overcome this deficiency.

In Comparative Example 3, in Table 4, a maleated polypropylene emulsion was made from Epolene G-3003 maleated polypropylene according to the procedure of Example 4 using the desirable low 7.8 phr level of oleic acid co-surfactant, but with a non-ionic surfactant mixture having a higher HLB of 10.7 produced by adding a 53/47 mixture of Brij 30 surfactant and Genapol UD-50 surfactant to the charge. In previous Example 4, a very good maleated polypropylene emulsion was obtained which had a transmittance value of 27%. However, in Comparative Example 3, a poor emulsion resulted which filtered slowly and exhibited a % transmittance value of only 6% due to the increase in the HLB value of the non-ionic surfactant to 10.7. The maleated polypropylene emulsions of Examples 4 and 7, where the non-ionic surfactant had calculated HLB values of 8.8 and 7.4 respectively, were of a similar good quality.

TABLE 4

| | Example | | | | | |
|---|---|---|---|---|---|---|
| | Comp. 2 | Ex. 3 | Ex. 6 | Comp. 3 | Ex. 4 | Ex. 7 |
| Epolene G-3003 (parts) | 100 | 100 | 100 | 100 | 100 | 100 |
| (typical 26 wt % in emulsion) | | | | | | |
| Carboxylic Acid Co- | | | | | | |
| Surfactant | | | | | | |
| Fatty Acid (phr) | 11.6 | 11.6 | 11.6 | 7.8 | 7.8 | 7.8 |
| Non-Ionic Surfactant | | | | | | |
| HLB | 10.4 | 8.5 | 7.4 | 10.7 | 8.8 | 7.4 |
| Amount (phr) | 17 | 17 | 17 | 17 | 17 | 17 |
| Recovered Emulsion | | | | | | |
| Yield (%) | 97.8% | 98.9% | 99.2% | 94.5% | 98.3% | 97.7% |
| Residue (grams) | 2-3 g. | <1 g. | Slight | ˜10 g. | 1-2 g. | 3.5 g. |
| % Transmittance | 1.3% | 17.5% | 14.4% | 6.2% | 27.4% | 23.3% |
| Filtration | Slow | Fast | V. Fast | Slow | V. Fast | Fast |
| Overall Emulsion | Poor | Very | Very | Poor | Excellent | Very |
| Quality | | Good | Good | | | Good |

### Examples 8-13

### Addition of Alicyclic Carboxylic Acid

In Table 5, a series of maleated polypropylene emulsions were prepared from Epolene G-3003 maleated polypropylene produced by Eastman Chemical Company using a non-ionic surfactant mixture with a HLB value of 8.5, but where the total level of carboxylic acid co-surfactant was varied from 17.8 phr down to 9.5 phr and additionally the proportion of Foral AX-E and oleic acid in the carboxylic acid co-surfactant portion of the charge was varied. In Examples 1 and 2, where the carboxylic acid co-surfactant was added at the highest levels, it was previously noted that the substitution of Foral AX-E hydrogenated rosin acid for an equal portion of linear organic carboxylic acid greatly improved emulsion quality.

Examples 8, 9, and 10 were made according to the same procedure as Example 3 using 11.6 phr of carboxylic acid co-surfactant but with different proportions of Foral AX-E hydrogenated rosin acid and oleic acid. At this lower level of carboxylic acid co-surfactant, the use of Foral AX-E rosin acid again significantly improved emulsion quality, but the effect was not as dramatic as in the previous examples. The best maleated polypropylene emulsion was prepared in Example 10 using the highest proportion of Foral AX-E rosin acid in the carboxylic acid co-surfactant mix, and the preferred 8.5 HLB of the non-ionic surfactant mixture.

In Examples 11, 12, and 13, a series of maleated polypropylene emulsions were made from Epolene G-3003 maleated polypropylene using only 9.5 phr of carboxylic acid co-surfactant. When the carboxylic acid co-surfactant loading was reduced to this level, the maleated polypropylene emulsion of Example 11, where oleic acid was used alone as the co-surfactant, exhibited excellent emulsion characteristics. The maleated polypropylene emulsions of Examples 12 and 13 where 55% and 73% of the oleic acid was replaced by Foral AX-E hydrogenated rosin acid were nonetheless superior to the emulsion of Example 11, exhibiting high % transmittance values of about 34%. In all instances, replacing part of the linear organic carboxylic acid by Foral AX-E hydrogenated rosin acid improved emulsion quality. The only difference is that the quality of the maleated polypropylene emulsion made using linear organic carboxylic acid alone as the carboxylic acid co-surfactant improved substantially as the level of the linear organic carboxylic acid in the emulsion formula is reduced to an optimal level of about 8-12 phr.

TABLE 5

| | Example | | | | | | | | | |
|---|---|---|---|---|---|---|---|---|---|---|
| | Comp. | | | | | | | | | |
| | Ex. 1 | Ex. 1 | Ex. 2 | Ex. 3 | Ex. 8 | Ex. 9 | Ex. 10 | Ex. 11 | Ex. 12 | Ex. 13 |
| Epolene G-3003, parts | 100 | 100 | 100 | 100 | 100 | 100 | 100 | 100 | 100 | 100 |
| (typically 26 wt % in | | | | | | | | | | |
| emulsion) | | | | | | | | | | |
| Total Carboxylic | 17.8 | 17.8 | 17.8 | 11.6 | 11.6 | 11.6 | 11.6 | 9.5 | 9.5 | 9.5 |
| Acid Surfactant | | | | | | | | | | |
| Fatty Acid (phr) | 17.8 | 10.5 | 7.3 | 11.0 | 7.1 | 6.2 | 2.7 | 9.5 | 4.3 | 2.6 |
| Foral AX-E (phr) | — | 7.3 | 10.5 | — | 4.5 | 5.4 | 8.9 | — | 5.2 | 6.9 |
| Non-Ionic | | | | | | | | | | |
| Surfactant | | | | | | | | | | |
| HLB | 8.5 | 8.5 | 8.5 | 8.5 | 8.5 | 7.4 | 8.5 | 8.5 | 8.5 | 8.5 |
| Amount (phr) | 17 | 17 | 17 | 17 | 17 | 17 | 17 | 17 | 17 | 17 |
| Recovered Emulsion | | | | | | | | | | |
| Yield (%) | 97.0% | 99.0% | 99.3% | 98.9% | 99.0% | 99.0% | 99.3% | 99.1% | 97.8% | 98.8% |
| Residue (grams) | 1-2 g | Trace | <1 g | <1 g. | Trace | Trace | <1 g. | Trace | 2.5 g. | <1 g. |
| % Transmittance | 2.8% | 29.6% | 32.5% | 17.5% | 27.9% | 26.5% | 31.5% | 23.7% | 34.0% | 34.1% |
| Filtration | V. Slow | V. Fast | V. Fast | Fast | V. Fast | V. Fast | V. Fast | V. Fast | V. Fast | V. Fast |
| Overall Emulsion | Poor | Excellent | Excellent | V. Good | Excellent | Excellent | Excellent | Excellent | Excellent | Excellent |
| Quality | | | | | | | | | | |

### Comparative Examples 4 and 5, Example 14

### Amount and Type of Surfactant

Comparative Examples 4 and 5 are listed in Table 6 where emulsions using high levels of carboxylic acid co-surfactant and non-ionic surfactants with high HLB values. Comparative Examples 4 and 5 were produced using direct emulsification procedures run in the same manner in a 300 ml pressure reactor from Parr Equipment Company as the other examples in this application. In Comparative Examples 4 and 5, Epolene G-3003 maleated polypropylene was added to the charge at a 21% by weight level, lower than the 26%-27% used in all the previous examples

The maleated polypropylene, non-ionic surfactant, carboxylic acid co-surfactant, and water were added to the reactor to produce an emulsification mixture. When the emulsification was conducted, the emulsification mixture was heated under pressure to 178° C. followed by cooling at a rate of just below 1° C. per minute. The maleated polypropylene failed to emulsify, and the product found upon opening the reactor was a solid powdery type material with little liquid. The liquid ingredients were absorbed into or encapsulated by the maleated polypropylene which solidified on cooling to form a low strength material which was ground up by the agitator. The emulsion ingredients totally failed to cause the maleated polypropylene to invert during the emulsification procedure to form a stable functionalized polyolefin emulsion.

In stark contrast, Example 14 was conducted using the same procedure as Comparative Examples 4 and 5 except the HLB of the non-ionic surfactant was 8.5, the carboxylic acid co-surfactant was added at a much lower 11.6 phr level, and 70% of the carboxylic acid co-surfactant charge consisted of Foral AX-E hydrogenated rosin acid with the remainder being oleic acid. The composition in Example 14 of the emulsification ingredients reflect what the inventor has found to be a desired range for causing the emulsification of high molecular weight maleated polypropylene with lower grafting levels. The maleated polypropylene emulsion of Example 14 was excellent, exhibiting very fast filtration, minimal residue, and a high % transmittance of 33%. Comparative Examples 4 and 5 and Example 14 show that the logic of using high levels of carboxylic acid co-surfactant in combination with non-ionic surfactants having high HLB values is clearly flawed, and the best emulsification agents are those selected according to the teachings disclosed in this specification.

TABLE 6

| | Example | | |
|---|---|---|---|
| | Comp. | Comp. | |
| | Ex. 4 | Ex. 5 | Ex. 14 |
| Epolene G-3003, parts | 100 | 100 | 100 |
| (typical 26 wt % in emulsion) | 21% | 21% | 26% |
| Total Carboxylic Acid Co- | 24 | 20 | 11.6 |
| surfactant | | | |
| Fatty Acid (phr) | 24.0 | 20.0 | 3.6 |
| Foral AX-E (phr) | — | — | 8.0 |
| Non-Ionic Surfactant | | | |
| HLB | 16.0 | 15.3 | 8.5 |
| Amount (phr) | 18.0 | 20.1 | 17.0 |
| Recovered Emulsion Yield (%) | Did Not | Did Not | 98.7% |
| Residue (grams) | Emulsify | Emulsify | Trace |
| % Transmittance | N/A | N/A | 33.4% |
| Filtration | Solid | Solid | V. Fast |
| Overall Emulsion Quality | All Solid | All Solid | Excellent |

### Particle Size Distributions for Emulsions Prepared in Comparative Examples 1 and 2 and Examples 1, 3, 4, 11, 12, and 14

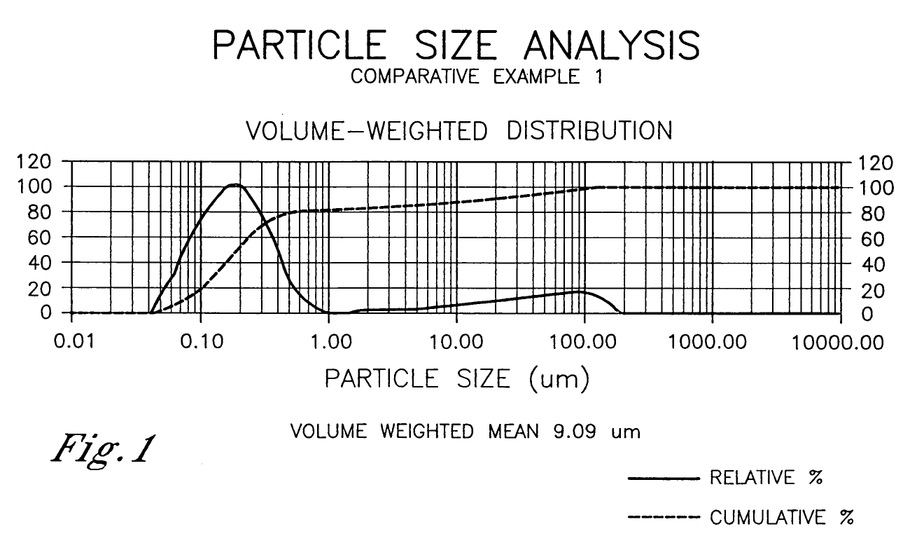

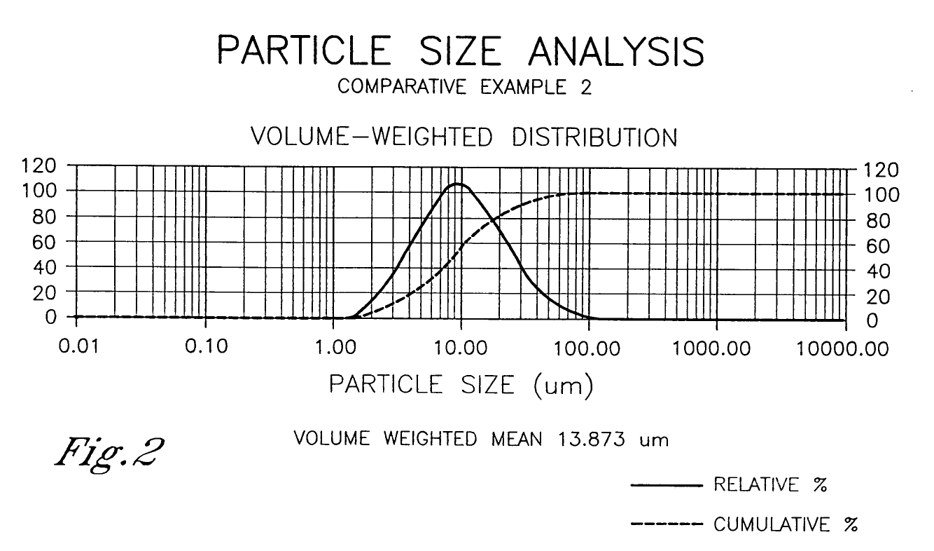

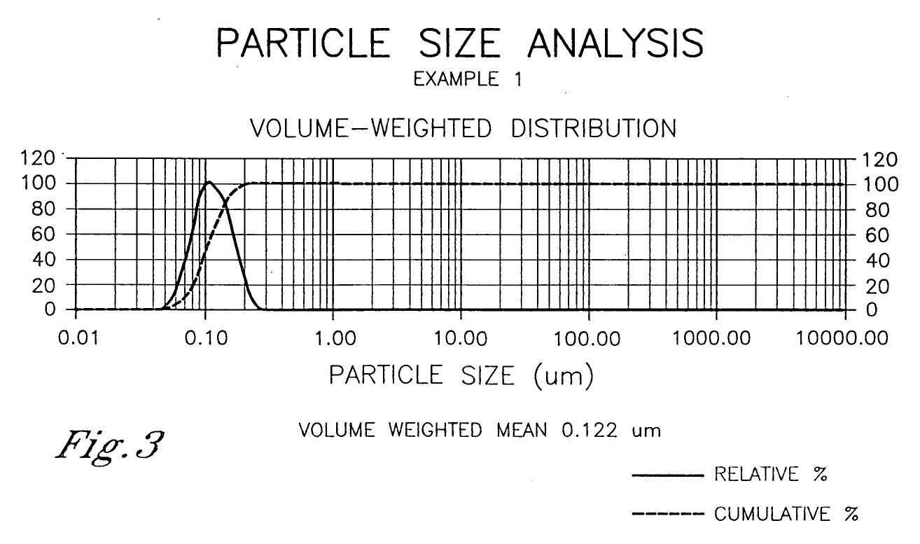

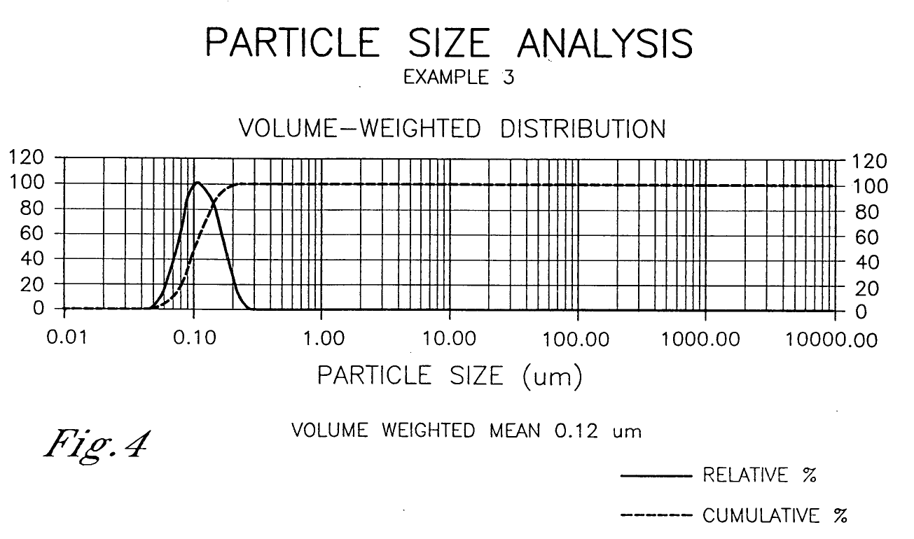

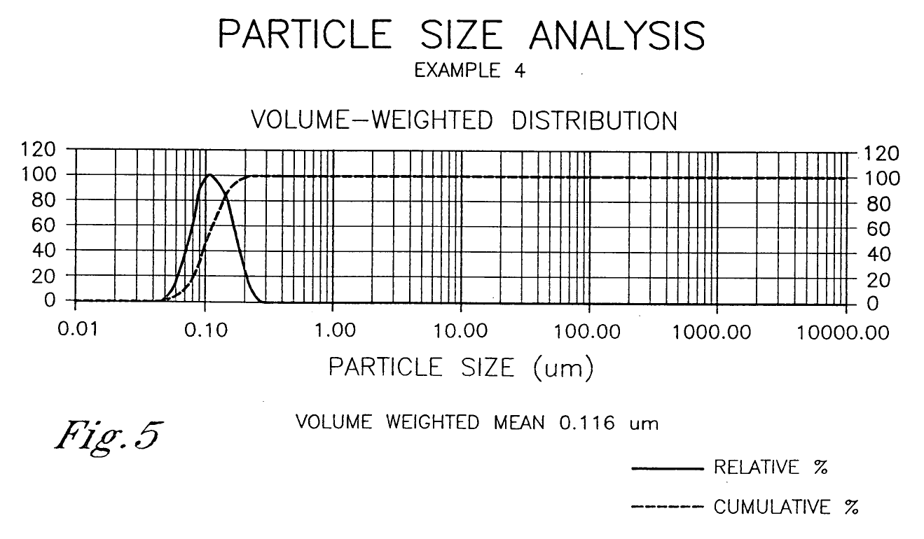

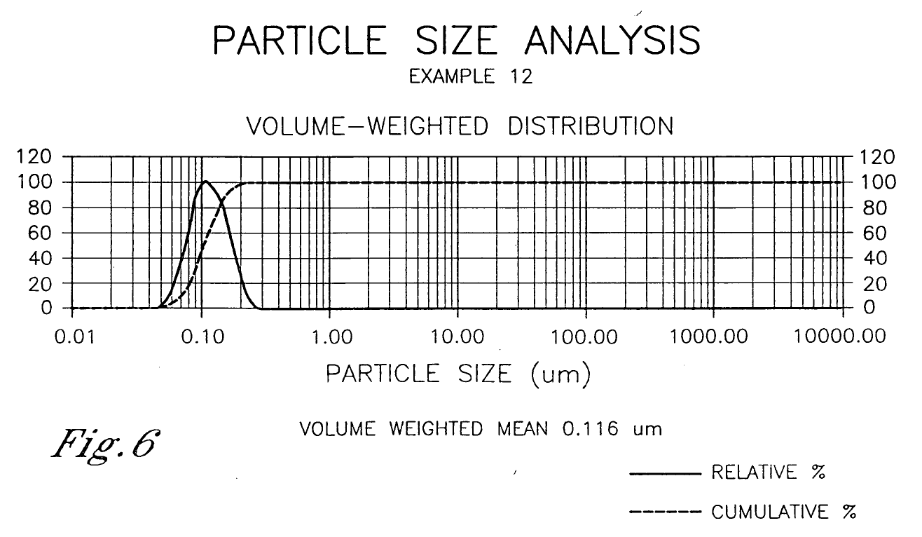

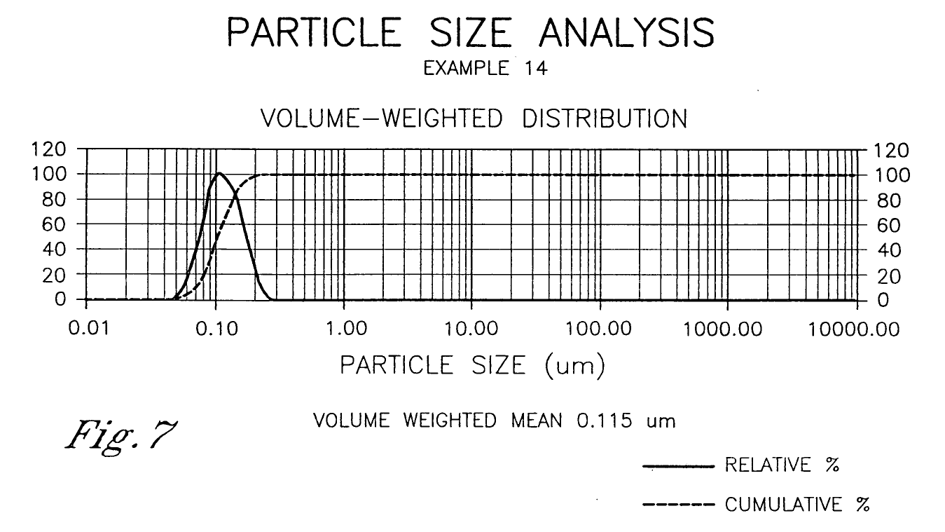

FIGS. 1-7 show the particle size distributions for Comparative Examples 1 and 2 and Examples 1, 3, 4, 12, and 14. In addition, Table 7 shows the particle size data for Comparative Examples 1 and 2 and Examples 1, 3, 4, 11, 12, and 14.

Particle size quality as shown in Table 7 was determined qualitatively by coating a glass slide with the emulsion and allowing it to dry in an inverted position to form a thin film. A rough coating suggested the presence of gels or grit and therefore poor quality while a smooth coating suggested small particle size leading to good transmittance and therefore an excellent quality.

TABLE 7

| | | | Mode | | |
|---|---|---|---|---|---|
| | | | (apex of | | |
| | Mean | Median | tallest | | Particle |
| | Diameter | Diameter | peak) | Span | Size |
| Example # | (microns) | (microns) | (microns) | (microns) | Quality |
| Comparative | 9.09 | 0.215 | 0.176 | 146.949 | Poor |
| 1 | | | | | |
| Comparative | 13.873 | 10.202 | 10.319 | 2.374 | Poor |
| 2 | | | | | |
| Example 1 | 0.122 | 0.116 | 0.116 | 0.827 | Excellent |
| Example 3 | 0.12 | 0.115 | 0.116 | 0.811 | Excellent |
| Example 4 | 0.116 | 0.111 | 0.111 | 0.804 | Excellent |
| Example 11 | 0.116 | 0.11 | 0.11 | 0.802 | Excellent |
| Example 12 | 0.116 | 0.111 | 0.11 | 0.803 | Excellent |
| Example 14 | 0.115 | 0.11 | 0.11 | 0.802 | Excellent |

### Examples 15-21

### Use of Additives in Maleated Polypropylene Emulsions To Improve Color

In Example 15, a maleated polypropylene product was made by the procedure used to manufacture Epolene G-3003 maleated polypropylene where the reactant flows (maleic anhydride and peroxide) were increased by 15% to produce a material having a graft level nominally 15% greater than the level present in standard Epolene G-3003 maleated polypropylene manufactured by Eastman Chemical Co. and characterized by an acid number value of 10.5 mg KOH/g. This maleated polypropylene made by this procedure is listed as G-3003X in Table 8.

In Examples 16 through 19 in Table 8, maleated polypropylene emulsions were made from conventional Epolene G-3003 maleated polypropylene produced by Eastman Chemical Company having a nominal 9 mg KOH/g. acid number where the maleated polypropylene emulsion was made by a direct method with stirring at 172° C. The ingredients used to emulsify the maleated polypropylene are listed in Table 8. The emulsion formulations were very similar, the only difference being that Example 16 contained no hypophosphorous acid (HPA) and potassium hydroxide (KOH). Example 17 contained low levels of hypophosphorous acid and sodium metabisulfite. Example 18 contained two times the amount of HPA+KOH as Example 17, and Example 19 contained three times the amount of additive as Example 17. All the maleated polypropylene emulsions were very good quality with no residue and fast filtration characteristics. The transmittance value of the formulations was very sensitive to the amount of HPA and KOH in the maleated polypropylene emulsion, with little increase between Examples 18 and 19.

Commercial Epolene G-3003 maleated polypropylene produced by Eastman Chemical Company can be effectively emulsified according to the procedures described herein. The addition of low levels of potassium hydroxide neutralized hypophosphorous acid or hypophosphorous acid alone to the emulsion formulation can serve both as a stabilizer to improve the heat aged color of the maleated polypropylene emulsion and also to improve the quality of the emulsion, increasing the transmittance of the emulsion.

The maleated polypropylene of Example 15 was emulsified by a direct method using the ingredients listed in Table 8. In Example 20, no hypophosphorous acid was added to the emulsion charge while in Example 21 hypophosphorous acid and KOH were added at the levels indicated. There was no significant increase in transmittance values for the maleated polypropylene emulsions of Examples 20 and 21 due to the addition of the hypophosphorous acid color stabilizer. Commercial Epolene G-3003 maleated polypropylene can be emulsified well according to the procedures described herein, but increasing the maleation of the maleated product by only about 15% to 25% can improve emulsification characteristics further and make the emulsification procedure less sensitive to small changes in formulation or additional ingredients.

TABLE 8

| | Example No. | | | | | |
|---|---|---|---|---|---|---|
| | 16 | 17 | 18 | 19 | 20 | 21 |
| Maleated PP | G-3003 | G-3003 | G-3003 | G-3003 | G-3003X | G-3003X |
| (%) | 26 | 26 | 26 | 26 | 26 | 26 |
| Non-ionic Surfactant | 4.3% | 4.3% | 4.3% | 4.3% | 4.3% | 4.3% |
| HLB | 9.0 | 9.0 | 9.0 | 9.0 | 9.5 | 9.5 |
| Foral AX-E | 1.4% | 1.4% | 1.4% | 1.4% | 1.4% | 1.4% |
| Oleic Acid | 1.8% | 1.8% | 1.8% | 1.8% | 1.8% | 1.8% |
| DMAMP-80 | 2.4% | 2.4% | 2.4% | 2.4% | 2.6% | 2.6% |
| 50% Hypophosphorous Acid | — | 0.11% | 0.23% | 0.36% | — | 0.23% |
| Potassium Hydroxide | — | 0.05% | 0.10% | 0.15% | — | 0.10% |
| Sodium Metabisulfite | 0.10% | 0.10% | 0.10% | 0.10% | 0.10% | 0.10% |
| Residue | None | None | None | None | None | None |
| Filtration Speed | V. Fast | V. Fast | V. Fast | V. Fast | V. Fast | V. Fast |
| % Transmittance | 15.6 | 27.4 | 38.5 | 41.2 | 43.3 | 46.5 |

### Examples 22-25

### Use of Saturated Fatty Acids as Carboxylic Acid Co-Surfactants in Maleated Polypropylene Emulsions

As described above in Example 18, a maleated polypropylene emulsion was made from standard Eastman Epolene G-3003 maleated polypropylene using both Foral AX-E rosin acid and oleic acid as carboxylic acid co-surfactants. In Example 22, a similar maleated polypropylene emulsion was prepared where the unsaturated oleic acid was replaced by stearic acid. An excellent emulsion resulted with transmittance values even higher than for Example 18 using oleic acid. In Example 23, a maleated polypropylene emulsion was prepared in the same manner as in Example 22 but where ⅓ of the Foral AX-E rosin acid in the charge was also replaced by an equal amount of stearic acid. Again, an excellent emulsion resulted with similar properties as the previous two maleated polypropylene emulsions. These examples serve to demonstrate that the straight chain fatty acid used in this invention can be saturated types of fatty acids which are typically crystalline waxes in their pure state. Being saturated and less susceptible to oxidation can be an advantage for this type of carboxylic acid co-surfactant when color stability is important.

In previous Example 21, a maleated polypropylene according to Example 15, similar to Eastman Epolene G-3003 but having a 15% higher graft level, was emulsified using both Foral AX-E rosin acid and oleic acid as carboxylic acid co-surfactants. In Example 24, a similar maleated polypropylene emulsion was prepared as in Example 21 where the amount of Foral AX-E rosin acid was reduced and the oleic acid was replaced by a mixture of stearic acid and Prisorine 3501 isostearic acid obtained from Uniqema. An excellent emulsion resulted with similar properties as Example 21. In Example 25, a maleated polypropylene emulsion was prepared in the same manner as Example 24 except the amounts of stearic and isostearic acid were reversed so that 78% of the C₁₈ saturated fatty acid was isostearic acid. Again, an excellent emulsion resulted with similar properties as in Examples 21 and 24. Isostearic acid is a branched fatty acid and non-crystallizing. It can be advantageous to use saturated fatty acids which are non-crystallizing in this invention, and it has been demonstrated that they are effective carboxylic acid co-surfactants when used at the levels and according to the limitations of this invention.

TABLE 9

| | Example No. | | | | | |
|---|---|---|---|---|---|---|
| | 18 | 22 | 23 | 21 | 24 | 25 |
| Maleated PP | G-3003 | G-3003 | G-3003 | G-3003X | G-3003X | G-3003X |
| (%) | 26 | 26 | 26 | 26 | 26 | 26 |
| Non-ionic Surfactant | 4.3% | 4.3% | 4.3% | 4.3% | 4.3% | 4.3% |
| HLB | 9.0 | 9.0 | 9.0 | 9.5 | 9.5 | 9.5 |
| Foral AX-E | 1.4% | 1.4% | 0.9% | 1.4% | 0.5% | 0.5% |
| Oleic Acid | 1.8% | — | — | 1.8% | — | — |
| Stearic Acid | — | 1.8% | 2.3% | — | 1.3% | 0.5% |
| Prisorine 3501 Isostearic Acid | — | — | — | — | 0.9% | 1.8% |
| DMAMP-80 | 2.4% | 2.4% | 2.4% | 2.6% | 2.3% | 2.4% |
| 50% Hypophosphorous Acid | 0.23% | 0.26% | 0.23% | 0.23% | 0.23% | 0.40% |
| Potassium Hydroxide | 0.10% | 0.15% | 0.10% | 0.10% | 0.10% | 0.15% |
| Sodium Metabisulfite | 0.10% | 0.10% | 0.10% | 0.10% | 0.10% | 0.10% |
| Residue | None | None | None | None | None | None |
| Filtration Speed | V. Fast | V. Fast | V. Fast | V. Fast | V. Fast | V. Fast |
| % Transmittance | 38.9 | 41.7 | 38.5 | 48.4 | 46.9 | 49.7 |

The invention has been described in detail with particular reference to preferred embodiments thereof, but it will be understood that variations and modifications can be effected within the spirit and scope of the invention.

That which is claimed is:

1. A functionalized polyolefin emulsion comprising at least one functionalized polyolefin, at least one non-ionic surfactant, at least one neutralizing base, at least one carboxylic acid co-surfactant, and water; wherein said functionalized polyolefin has a grafting level ranging from about 0.5% by weight to about 2.5% by weight grafted functionalizing agent based on the weight of the functionalized polyolefin; and wherein said non-ionic surfactant has a HLB ranging from about 4 to about 10; and wherein said carboxylic acid co-surfactant comprises at least one linear organic carboxylic acid in an amount less than or equal to 16 parts per hundred parts of said functionalized polyolefin.

2. A functionalized polyolefin emulsion comprising at least one functionalized polyolefin, at least one non-ionic surfactant, at least one neutralizing base, at least one carboxylic acid co-surfactant, and water wherein said functionalized polyolefin has a grafting level ranging from about 0.5% by weight to about 2.5% by weight grafted functionalizing agent based on the weight of said functionalized polyolefin; wherein said non-ionic surfactant has a HLB ranging from about 4 to about 10; wherein said carboxylic acid co-surfactant comprises at least one linear organic carboxylic acid and at least one alicyclic organic carboxylic acid; and wherein the total amount of said carboxylic acid co-surfactant is greater than 16 parts per hundred parts of said functionalized polyolefin.

3. A functionalized polyolefin emulsion comprising at least one functionalized polyolefin, at least one non-ionic surfactant, at least one neutralizing base, at least one carboxylic acid co-surfactant, and water; wherein said carboxylic acid co-surfactant comprises at least one alicyclic organic carboxylic acid.

4. A functionalized polyolefin emulsion comprising at least one functionalized polyolefin, at least one non-ionic surfactant, at least one neutralizing base, at least one carboxylic acid co-surfactant, and water wherein said functionalized polyolefin has a grafting level from about 0.5% by weight to about 2.5% by weight grafted functionalizing agent based on the weight of the functionalized polyolefin; and wherein said functionalized polyolefin emulsion has a % transmittance of at least 5%.

5. A functionalized polyolefin emulsion according to any one of claims 1-4 wherein said polyolefin comprises at least one olefin monomer having from 2 to about 8 carbon atoms.

6. A functionalized polyolefin emulsion according to claim 5 wherein said polyolefin is selected from the group consisting of polyethylene, polypropylene, polybutene, and polyhexene.

7. A functionalized polyolefin emulsion according to claim 6 wherein said polyolefin is selected from the group consisting of homopolymers and copolymers of low, medium, and high density polyethylene and homopolymers and copolymers of crystalline and amorphous polypropylenes.

8. A functionalized polyolefin emulsion according to any one of claims 1-4 wherein said functionalized polyolefin is grafted with a functionalizing agent; and wherein said functionalizing agent is any unsaturated monomer containing one or more carboxylic acid or acid anhydride groups.

9. A functionalized polyolefin emulsion according to claim 8 wherein said functionalizing agent is selected from the group consisting of carboxylic acids and acid anhydrides.

10. A functionalized polyolefin emulsion according to claim 9 wherein said functionalizing agent is selected from the group consisting of acrylic acid, methacrylic acid, maleic acid, flumaric acid, himic acid, itaconic acid, citraconic acid, mesaconic acid, methacrylic acid, crotonic acid, isocrotonic acid, maleic anhydride and himic anhydride.

11. A functionalized polyolefin emulsion according to claim 10 wherein said functionalizing agent is maleic anhydride.

12. A functionalized polyolefin emulsion according to any one of claims 1-4 wherein said functionalized polyolefin is maleated polypropylene and the grafting level of said maleated polypropylene ranges from about 1% by weight to about 2.5% by weight grafted maleated anhydride based on the weight of the maleated polypropylene.

13. A functionalized polyolefin emulsion according to any one of claims 1-4 wherein the acid number of said functionalized polyolefin ranges from about 4 to about 14.

14. A functionalized polyolefin emulsion according to claim 13 wherein the acid number of said functionalized polyolefin ranges from about 7 to about 12.

15. A functionalized polyolefin emulsion according to any one of claims 1-4 wherein the weight average molecular weight of said functionalized polyolefin ranges from about 30,000 to about 90,000.

16. A functionalized polyolefin emulsion according to claim 15 wherein the weight average molecular weight of said functionalized polyolefin ranges from 40,000 to 70,000.

17. A functionalized polyolefin emulsion according to any one of claims 1-4 wherein the melt viscosity at 190° C. of said functionalized polyolefin ranges from about 20,000 centipoise to about 150,000 centipoise.

18. A functionalized polyolefin emulsion according to any one of claims 1-4 wherein the peak melt point of said functionalized polyolefin is greater than about 135° C.

19. A functionalized polyolefin emulsion according to any one of claims 1-4 wherein the amount of the functionalized polyolefin contained in the functionalized polyolefin emulsion ranges from about 10% by weight to about 35% by weight based on the weight of the functionalized polyolefin emulsion.

20. A functionalized polyolefin emulsion according to any one of claims 1-4 wherein said non-ionic surfactant has a HLB value ranging from about 6 to about 10.

21. A functionalized polyolefin emulsion according to claim 20 wherein said non-ionic surfactant has a HLB value ranging from about 7 to about 10.

22. A functionalized polyolefin emulsion according to any one of claims 1-4 wherein said non-ionic surfactant comprises at least one compound based on ethylene oxide or alkyl phenols.

23. A functionalized polyolefin emulsion according to claim 22 wherein said non-ionic surfactant is at least one selected from the group consisting of ethoxylated derivatives of C₈ to C₂₀ linear alcohols, ethoxylated C₉ to C₁₈ synthetic branched alcohols, ethoxylated alkyl phenol derivatives, mono esters of aliphatic carboxylic acids, polyethylene oxide oligomers of varying molecular weight, similar mono- or di-esters of polyhydroxy material, and mixtures thereof.

24. A functionalized polyolefin emulsion according to claim 23 wherein said non-ionic surfactant is based on the reaction of alcohols or alkyl phenols with ethylene oxide, propylene oxide, or mixtures of the two.

25. A functionalized polyolefin emulsion according to any one of claims 1-4 wherein the amount of said non-ionic surfactant present in said functionalized polyolefin emulsion ranges from about 6 parts per 100 parts of functionalized polyolefin to about 25 parts per 100 parts of functionalized polyolefin.

26. A functionalized polyolefin emulsion according to claim 25 wherein the amount of said non-ionic surfactant present in said functionalized polyolefin emulsion ranges from about 12 parts per 100 parts of functionalized polyolefin to about 18 parts per 100 parts of functionalized polyolefin.

27. A functionalized polyolefin emulsion according to any one of claims 1-4 wherein said carboxylic acid co-surfactant is at least one selected from the group consisting of linear organic carboxylic acids and alicyclic organic carboxylic acids.

28. A functionalized polyolefin emulsion according to claim 27 wherein said linear organic carboxylic acid is at least one selected from the group consisting of linear C₁₆ to C₁₈ fatty acids.

29. A functionalized polyolefin emulsion according to claim 27 wherein said alicyclic organic carboxylic acid is at least one rosin acid.

30. A functionalized polyolefin emulsion according to claim 29 wherein said alicyclic organic carboxylic acid is at least one hydrogenated rosin acid.

31. A functionalized polyolefin emulsion according to claim 1 wherein said carboxylic acid co-surfactant is at least one linear organic carboxylic acid in an amount ranging from about 2 to about 16 parts per hundred parts of functionalized polyolefin.

32. A functionalized polyolefin emulsion according to claim 1 wherein said carboxylic acid co-surfactant is at least one linear organic carboxylic acid in an amount ranging from 8 to 12 parts per hundred parts of functionalized polyolefin.

33. A functionalized polyolefin emulsion according to any one of claims 1-4 wherein said carboxylic acid co-surfactant is at least one linear organic carboxylic acid and at least one alicyclic organic carboxylic acid.

34. A functionalized polyolefin emulsion according to any one of claims 1 or 3 wherein the total amount of carboxylic acid co-surfactant in said functionalized polyolefin emulsion is greater than 8 parts per hundred parts of functionalized polyolefin.

35. A functionalized polyolefin emulsion according to claim 34 wherein the total amount of carboxylic acid co-surfactant in said functionalized polyolefin emulsion ranges from about 8 parts to about 25 parts per hundred parts of functionalized polyolefin.

36. A functionalized polyolefin emulsion according to claim 33 wherein the amount of said alicyclic organic carboxylic acid ranges from about 1% by weight to about 99% by weight of the total amount of carboxylic acid co-surfactant.

37. A functionalized polyolefin emulsion according to claim 36 wherein the amount of said alicyclic organic carboxylic acid ranges from about 25% by weight to about 75% by weight of the total amount of carboxylic acid co-surfactant.

38. A functionalized polyolefin emulsion according to claim 2 wherein the maximum amount of said carboxylic acid co-surfactant is 16 parts per 100 parts of functionalized polyolefin and the remainer of the carboxylic acid co-surfactant is an alicyclic carboxylic acid.

39. A functionalized polyolefin emulsion according to claim 3 wherein the amount of said alicyclic organic carboxylic acid ranges from about 5 parts to 25 parts per hundred parts of functionalized polyolefin.

40. A functionalized polyolefin emulsion according to any one of claims 1-4 wherein said neutralizing base is at least one organic compound having 1 to about 10 carbon atoms, an amino group, and a hydroxyl group.

41. A functionalized polyolefin emulsion according to claim 40 wherein said neutralizing base is selected from the group consisting of N,N-diethylethanolamine, N,N-dimethyl ethanolamine, 2-dimethylamino-2-methyl-1 propanol, 2-dimethylamino-1-propanol, or combinations thereof.

42. A functionalized polyolefin emulsion according to claim 40 wherein the amount of neutralizing base added is sufficient to neutralize about 80% to 100% of the total acidity in the functionalized polyolefin emulsion.

43. A functionalized polyolefin according to any one of claims 1-3 wherein the transmittance value of said functionalized polyolefin emulsion is greater than 5%.

44. A functionalized polyolefin according to any one of claims 1-4 wherein the transmittance value of said functionalized polyolefin emulsion is greater than 30%.

45. A sizing composition comprising said functionalized polyolefin emulsion of any one of claims 1-4.

46. An article comprising a functionalized polyolefin emulsion according to any one of claims 1-4.
